(19) United States
(12) Patent Application Publication
(10) Pub. No.: US 2011/0263402 A1
(43) Pub. Date: Oct. 27, 2011

(54) Apparatus and method for hygienically expediting the opening of agricultural produce bags or prepackaged meat bags

(76) Inventor: David G. Booher, Sparks, NV (US)

(21) Appl. No.: 13/092,129

(22) Filed: Apr. 21, 2011

Related U.S. Application Data
(60) Provisional application No. 61/326,666, filed on Apr. 22, 2010.

(51) Int. Cl. B65B 43/26; B31B 1/78

(52) U.S. Cl. 493/309

(57) ABSTRACT

This invention is an apparatus and process for hygienically expediting the opening of plastic bags that are typically used by customers of grocery businesses in the agricultural produce and prepackaged meat departments, for transporting and storing products. The apparatus would need to be installed at the store level in the previously mentioned departments for the customer's use. The apparatus described here includes signage that outlines the system's use, any type of sanitary fluid that has naturally diminishing adhesive qualities, a fluid dispenser that dispenses a small amount of fluid, and any thin film plastic bags or ones of similar compositions. When dispensed, the fluid enables the user's fingers to open the bags quickly and hygienically due to their temporary adhesive state.

### CROSS-REFERENCE TO RELATED APPLICATIONS

This application claims the benefit of provisional patent application Ser. No. 61/326,666, filed Apr. 22, 2010.

U.S. Pat. No. 4,601,690 (1984) shows a device for opening plastic bags using adhesive strips attached to a flexible U-shaped member. This device requires manufacturing for the member itself, custom made perishable adhesive strips that would require ongoing purchases and other cost inhibitive issues. Depending on the adhesive used it could also aid in the spread of germs, viruses and other pathogens which could be a cause for concern in it's use in food packaging.

U.S. Pat. No. 4,698,051 (1986) is another patent on the same device listed above in U.S. Pat. No. 4,601,690 and would therefore have the same limitations and areas of concern for either the end user or retailer who supplies the device to aid in food packaging.

### BACKGROUND OF THE INVENTION

Consumers who shop for agricultural produce and/or meats whether in a grocery store, open air market or any other setting where such products are sold, are exposed throughout their shopping experience to a wide variety of germs, viruses and other pathogens. A recent study by professor Charles Gerba of the University of Arizona even placed the occurrence of fecal bacteria on shopping carts at 72%. Other reports, including a study the Centers for Disease Control and Prevention (CDC) published entitled “Produce Handling and Processing Practices”, have shown that while many food borne illnesses are transmitted by the fecal-oral route, the bacteria's origin in the food chain is not always fully understood. Conversely it is widely understood with common health education today that hand washing is the single most important thing we can do to prevent the spread of illnesses. While most Americans believe this to be true, shockingly the majority of shoppers using these bags are still placing their fingers in their mouths or on their tongues to help expedite the process of opening said bags by their saliva's quality of adhesion. This is due to the many inherent qualities of thin film plastic bags that make their opposing sides difficult to separate. Therefore when people resort to the prior mentioned unhygienic practice they are potentially exposing themselves and subsequently their families, their co-workers and anyone else they come in contact with to a variety of illnesses. They are also sorting through produce and meat packages with their saliva moistened fingers, thereby increasing the potential spreading of germs, viruses and other pathogens. This practice would also increase the likelihood of fecal bacteria or other pathogens contaminating raw agricultural produce that has had it's skin punctured during sorting at the store level whether by employees or customers.

Furthermore for many of those who do not use this unhygienic method, the bags become the source of a frustrating shopping experience due to their difficulty to open. For many with health conditions such as joint pain, Parkinson's or some forms of arthritis these bags can take over a half a minute to open each and in more severe cases be completely impossible to open. This difficulty is not only frustrating and discouraging for the sufferer but at times results in the loss of a sale(s) for the business. Currently retailers in the field of agricultural produce and meat sales do not have any devices or systems in place for their customer's use to specifically address these problems that the inventor is aware of.

With the demand for the previously mentioned bags increasing daily due in part to population growth, an apparatus and method of opening such bags both hygienically and expeditiously would have far reaching health, financial, sociological and psychological benefits that extend well beyond the retailer or wholesaler and their customers. Other devices that seek to expedite the opening of said bags do not have the proper medium to prevent the spread of pathogens. They are typically also financially inhibitive in both production and in their recurring maintenance cost. To address these problems effectively the apparatus and method would have to be designed for implementation by retailers or wholesalers and would not be precluded by it's maintenance cost. In order to control maintenance costs it would be necessary for the apparatus to have fail-safe devices incorporated within it's structure that by design would help prevent misuse and/or overuse of any perishable part thereby directly safeguarding the wholesaler or retailer. This apparatus would also have to be easy enough to use so that a customer would not feel overly inconvenienced by the resultant process portion of this invention and avoid it's use all together.

### BRIEF SUMMARY OF THE INVENTION

The apparatus portion of this invention consists of a fluid dispenser that has it's dispersion limited to disperse a small amount of fluid onto the user's fingertip(s). Any type of hygienic fluid such as soap, sanitizer or moisturizer that when applied has naturally diminishing adhesive properties. Plastic bags for produce or meat storage and/or transport. Signage for the proper process of using the other parts in opening said produce bags. All of these parts would have to be installed so as to reduce travel time between the different mechanisms and the product the user is intending to place in the plastic bag. The principle idea or methodology to accomplish that goal for this invention is that of forming a “work triangle” or a distance between the apparatus's mechanisms that is as equal as it would be financially feasible for the retailer to install the different parts.

The process begins with the user reading the signage in order to determine how to properly use the apparatus. Next the user obtains their necessary bags. After that they use the dispenser to obtain a small amount of the hygienic fluid which is used to provide adhesion to the user's chosen appendage in order to open their bags. With this proper setup and use of the invention, customers of the retailer will be able to sanitarily open the plastic bags in a quick fashion thereby reducing personal frustration and possible contamination of both their immune systems and the products they touch. Logically in turn if infection is prevented a person's health and financial well being will likewise be benefited. The wetting of the fingers using a hygienic fluid versus licking one's fingers is minimally different by design in this invention so as to help ensure the system's use by individuals who previously used the unsanitary method.

Those with health conditions that cause difficulties in opening said bags could be spared from having to struggle with them, needing others to open the bags for them or feeling they have to avoid the purchases associated with said bags all together. For those that do not use unsanitary methods, the average time they normally take to open the bags would be greatly reduced by utilizing this apparatus and it's associated process thereby enhancing their overall shopping experience. Any of these benefits could result in more sales for the business.

### BRIEF DESCRIPTION OF THE SEVERAL VIEWS OF THE DRAWING

FIG. 1—is meant to illustrate how the individual parts of the apparatus, illustrated as bags 6, a fluid dispenser containing the hygienic fluid 8, signage 12, can be implemented within a produce area of a store.

FIG. 2—illustrates the principle of installing the parts to form a work triangle 14.

FIG. 3—shows two common dispenser types with a stint 5 installed.

### DETAILED DESCRIPTION OF THE INVENTION

The apparatus in the primary embodiment functions in such a manner as to allow for a user to interact with each of it's parts with as little travel time between mechanisms as the owner of the system deems financially or logistically feasible. The intent is to provide an apparatus and a resultant process that would allow for both hygienic and easy opening of thin film plastic bags that are primarily used for bagging raw agricultural produce in retail grocery stores or for bagging prepackaged meats that at times sweat or leak fluids during transport. The term “plastic bags” is intended to mean thin film bags that are made of plastic or a plastic sub component and are purposed in the store setting as described above. As the different parts of the apparatus are covered in this section a description of their relative need for plurality in the apparatus will be made or illustrated.

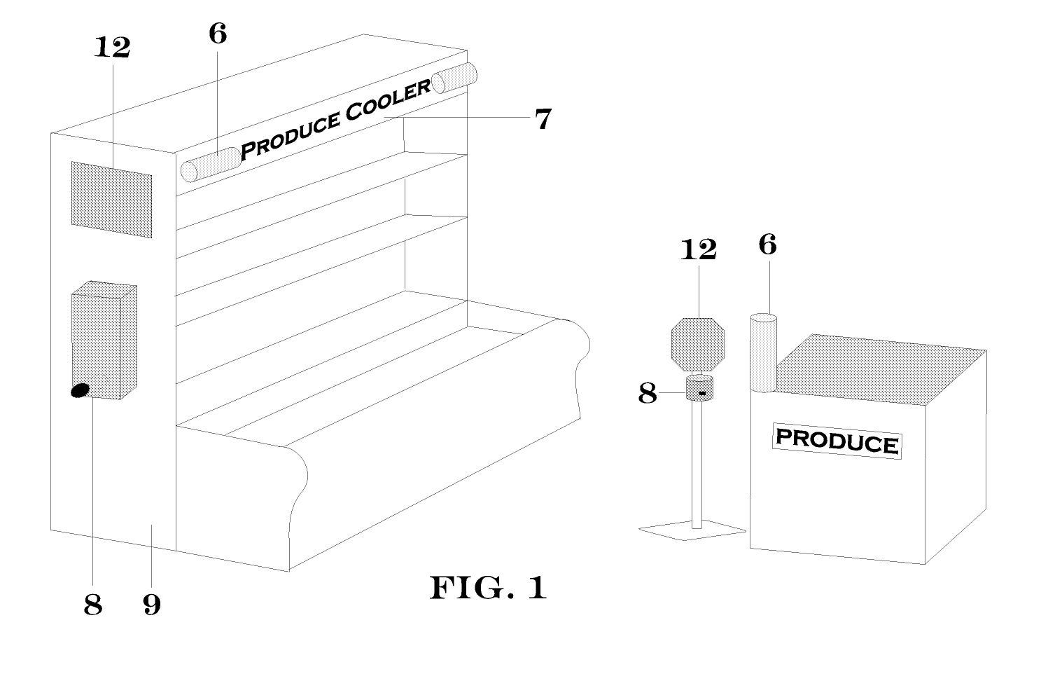

In FIG. 1 a basic raw agricultural produce area is illustrated. Bags 6 and hygienic fluid dispensers 8 are placed for easy access during the customer's shopping experience by using locations that allow for minimal movement between the product they wish to purchase and the apparatus's parts. Typically, any location for bag dispensing would be accompanied by a fluid dispenser for ease of use in the process. The dispensers are filled with any type of hygienic fluid such as but not limited to soap, sanitizer or moisturizer that is preferably free of excess lather and unnecessary oils when applied but also dissipates over time or through use so as to create as little burden to the user as possible. In other embodiments the hygienic fluid could be replaced with a hygienic gel.

The primary embodiment as illustrated in FIG. 1 shows the use of any type of soap, sanitizer or other fluid dispenser with either built in or externally equipped methods for limiting dispersion in order to facilitate the opening of the previously mentioned bags. The parameters for deciding how much fluid should be dispersed cannot be held to specific measurements of volume or mass as all fluids have different properties. Instead the dispersion amount should be determined by testing varied amounts of the specific hygienic fluid that will be used in the apparatus's process with the goal of opening the desired amount of bags that the business owner or grocery store's representative chooses. Once the amount of the specific fluid is determined then a mechanical dispenser with the necessary built in limits can be used or a stint can be placed on a chosen dispenser which will be described in the next paragraph. In other embodiments electronic “no-touch” or motion activated dispenser systems specially designed to release the necessary small amount of fluid could be used.

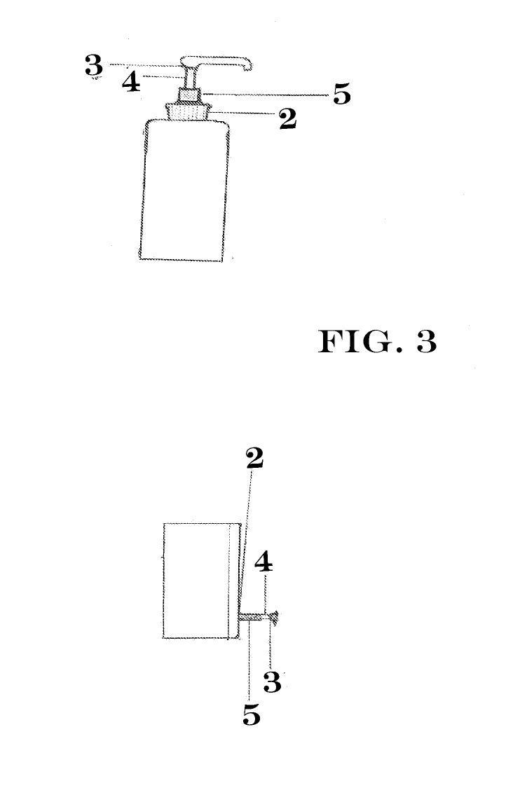

In FIG. 3 two common dispenser types are illustrated in order to show how in other embodiments a stint 5 could be used on a dispenser to specifically limit dispersion, thereby preventing potential overuse and/or misuse of the fluid since only a small portion is needed in the process. By limiting the fluid dispersion in the process with the stint it not only protects the apparatus's provider against unnecessary expenditures but it also benefits the customer. It does this by preventing an overly wet condition that would very likely be viewed as a nuisance by the customer. The stint can be made out of any combination or singularity of metal, polymer, glass or various organic materials that when formed make a tubular design. The stint acts as a sleeve in that it is placed over the plunger or pump shaft 4 externally. In order to prevent excess friction from the stint at least one sixteenth of an inch and at most an eighth of an inch of clearance between the inner circumference of the sleeve and the plunger or pump shaft should be calculated when designing the stint. The stint remains situated during it's use between the pump shaft or plunger base 2 and the pump handle 3. Next it is cut to a length that will limit the dispersion to the owner's desired amount therefore negating the need for expensive design and production changes of the dispenser itself at the manufacturing level. Using a stint also allows for economical adjustments in the dispenser's output when either willful or forced changes to the chosen hygienic fluid's composition cause a detrimental difference in dispersion characteristics. The overall circumference and physical composition of the stint is determined by the specific application and it's inherent requirements such as the amount of force that will be applied in the depression of the pump, the amount of everyday use the pump will receive, visual aesthetics to meet with the retailer's taste and other factors that naturally occur in stint type selection.

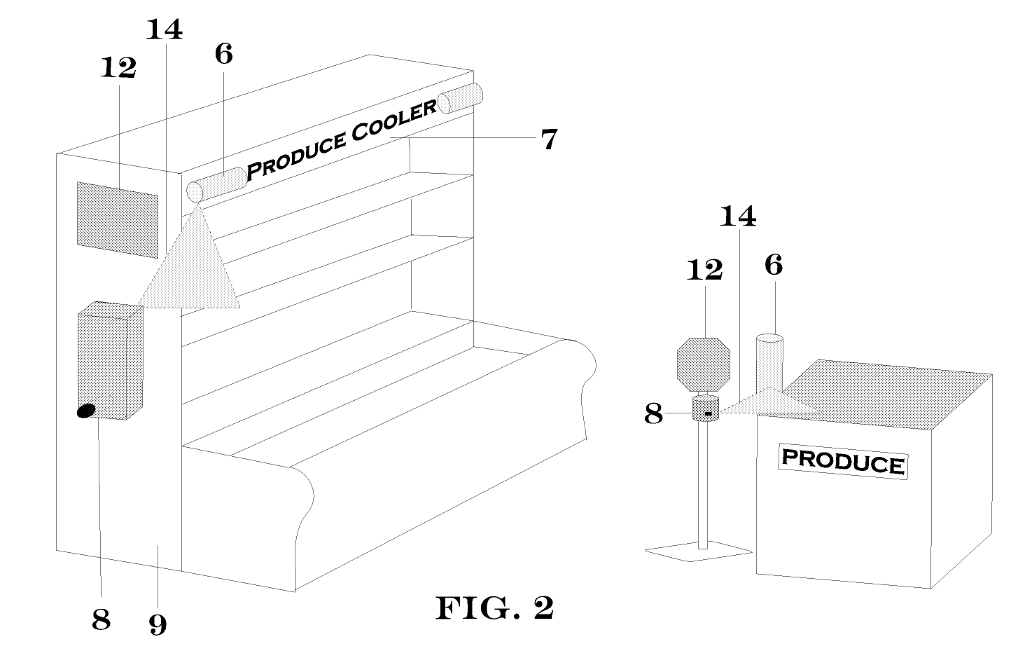

As shown in FIG. 2 the apparatus is assembled using the principle of forming a work triangle 14 between a location of the bags 6 a dispenser 8 of the hygienic fluid and the produce or meat the user is looking to purchase. The work triangle principle is defined as a method for discerning part installation locations with the idea of reducing travel time between the different mechanisms or parts, especially when the task requires repetition to complete. The main way this is done is by attempting to reduce the distance apart from each mechanism to an imaginary triangle with equal sides. The parts or mechanisms that make up the triangle would only be as equally small in distance apart as it would be financially reasonable to install. The work triangle principle has application within this method since the user of this system will typically purchase multiple items during their shopping experience and thereby be benefited with reduced travel times between the apparatus's parts. It is for this reason that a fluid dispenser should typically be installed within the average customer's arm reach of any location where bags are dispensed unless there is a potential hazard created by the fluid dispenser's installation. In FIG. 1 the bags are mounted on the top of the produce cooler 7 are at or above the average shopper's head. Therefore a fluid dispenser in this location could be a cause for concern as regards head injuries or possible eye injuries. In this case the business owner and installer would have to use discernment to either forgo installing a fluid dispenser or to install it in a less obtrusive area such as illustrated with the fluid dispenser on the side of the produce cooler 9.

The method or process used in conjunction with the apparatus and also regarded as part of this invention, begins with reading the signage 12 that includes an outline for proper use of the apparatus. Next the user unrolls and separates the bags they intend to use. The process continues with utilizing the dispenser to disperse a small amount of hygienic fluid onto the user's chosen physical appendage, typically and from here on out the fingers and thumb will be used for illustrative purposes although depending on the user's circumstances this could be altered. The fluid dispersed onto the fingertip(s) or thumb is limited to a small amount necessary for sufficiently wetting the user's finger(s). The fluid is then lightly rubbed into the finger(s) and thumb but not to the point of becoming dry. Instead a slightly moistened and sanitary state is retained whereby the finger(s) and thumb are changed to temporarily have hygienic adhesive properties for the purpose of using the adhesion to rapidly open said bags without having to resort to any unsanitary methods. The fact that the finger(s) new state is temporary and designed to diminish over time or through use is greatly beneficial because it prevents the user from becoming annoyed by a persistent stickiness after they are done opening their needed bags.

In other embodiments the signage describing how the apparatus should be used could include store advertising or directions. Also a mechanism could be used to wet the bags at their opening as they are dispensed so as to reduce steps in the process.

1. An apparatus for hygienically and expeditiously opening plastic bags primarily used in produce and meat sales departments in grocery markets or stores, comprising singularly or in plurality:
a) a fluid dispenser designed to limit the amount of fluid to specifically accomplish opening the aforementioned plastic bags;
b) a hygienic fluid that can provide a temporary adhesive state in order to open the intended plastic bags;
c) a roll or stack of plastic bags intended for produce or meat sales;
d) a sign(s) describing the proper use of the other parts of the apparatus;
e) a method of forming a work triangle during the installation of said parts so as to allow for a user of the apparatus to access it's mechanisms quickly during the process.

2. A process for using the apparatus in claim 1 so as to accomplish a faster and/or more hygienic method of opening bags typically used in produce and meat sales departments in grocery markets or stores comprising these steps but not limited to this order:
a) reading signage that describes the proper use of the apparatus in claim 2;
b) the user unrolls or unstacks their needed plastic bags;
c) using a fluid dispenser to dispense a hygienic fluid onto the users chosen physical appendage, typically the fingertip(s) or thumb, which is then rubbed in slightly so as to create the necessary adhesive state required in the next step;
d) the user now takes the intended opening end of a plastic bag between their moistened fingers and gently separates the sides by using their fingers temporary sanitary adhesive state;
e) the user continues to open their needed bags until the adhesive state is effectively diminished and needs to be reapplied through the dispenser or their needed bags are opened.

3. A stint used for limiting dispersion of existing fluid dispensers that could be substituted for the design built dispenser in claim 1.
